(19) United States
(12) Patent Application Publication
(10) Pub. No.: US 2009/0252952 A1
(43) Pub. Date: Oct. 8, 2009

(54) SURFACE TREATED CR-FREE STEEL SHEET FOR USED IN FUEL TANK, PREPARING METHOD THEREOF AND TREATMENT COMPOSITION THEREFOR

(75) Inventors: Sang-Keol Noh, Kyungsangbook-do (KR); Jae-Ryung Lee, Kyungsangbook-do (KR); Yong-Kyun Cho, Kyungsangbook-do (KR)

Correspondence Address: THE WEBB LAW FIRM, P.C., 700 KOPPERS BUILDING, 436 SEVENTH AVENUE, PITTSBURGH, PA, 15219, US

(73) Assignee: POSCO, Pohang (KR)

(21) Appl. No.: 12/159,033

(22) PCT Filed: Dec. 27, 2006
(86) PCT No.: PCT/KR06/05778

§ 371 Date: Jun. 24, 2008

(30) Foreign Application Priority Data
Dec. 27, 2005 (KR) 10-2005-0130382

(51) Int. Cl. B32B 5/16; B05D 3/02; B32B 27/08; C08L 63/00; C08K 3/10

(52) U.S. Cl. 428/328; 427/372.2; 427/387; 428/416; 428/336; 428/323; 523/451; 428/425.5; 524/413

(57) ABSTRACT

A Cr-free steel sheet includes a Zn-based electroplated steel sheet, a Cr-free layer which is formed by a Cr-free treatment liquid coated on the steel sheet, the Cr-free treatment liquid containing silicate of 3 to 40 parts by weight, silane of 0.5 to 10 parts by weight, titanium compound of 0.2 to 8 parts by weight, binder resin of 10 to 50 parts by weight, the binder resin being selected from the group consisting of urethane resin, epoxy resin and a combination thereof, and phosphoric ester of 1 to 5 parts by weight based on the Cr-free treatment liquid of 100 parts by weight, and a resin layer which is formed by a resin treatment liquid coated on the Cr-free layer, the resin treatment liquid containing melamine resin of 3 to 25 parts by weight, colloidal silica of 10 to 20 parts by weight, metal powder of 5 to 40 parts by weight, and phosphoric ester of 1 to 5 parts by weight based on phenoxy resin of 100 parts by weight.

### TECHNICAL FIELD

The present invention relates to a surface treated Cr-free steel sheet for use in a fuel tank, a preparation method thereof and treatment composition therefor, and more particularly, to a surface treated Cr-free steel sheet for use in a fuel tank which has high adhesive properties, corrosion resistance, fuel resistance and weldability, a preparation method thereof and treatment composition therefor.

### BACKGROUND ART

In substitution for a terne plated steel sheet presently used in a fuel tank of vehicle, a steel sheet made by treating a zinc (Zn) or Zn alloy plated steel sheet with chromate (Cr) and resin (without using lead) has been developed. The resin-treated steel sheet shows various performances according to the properties of the resin film. Korean Patent Registration No. 396084 discloses a conventional steel sheet which includes a Cr-containing film coated on a substrate steel sheet and an overlaid resin layer formed by a phenoxy resin film for the purpose of improving corrosion resistance and fuel resistance. But, because chrome is known as harmful to humans, e.g., causing disease like cancer, the use of chrome is regulated.

Accordingly, anti-corrosion agents containing no chrome have been developed. The representative anti-corrosion agent containing no chrome is one made by combination of high molecular substances and inorganic substances. Recently, anti-corrosion agents containing zirconium, silicate, titanium compound, etc. have been developed.

However, in order to have high corrosion resistance, the above compounds should be coated on a steel sheet with a coating amount larger than the conventional Cr-coating amount. Thus, there is problem that the conductivity and the adhesiveness to the overlaid resin layer are decreased. Typical features of a general Cr compound and a Cr-free compound are shown in the following table 1.

TABLE 1

| clssification | Cr film | Cr-free film | remarks |
|---|---|---|---|
| composition | inorganic:organic = | inorganic organic = | |
| | 90~95:5~10 parts | 50~60:40~50 parts | |
| | by weight | by weight | |
| film features | barrier effect andself | barrier effect due to | |
| | healing effect due to | the reaction of | |
| | the reaction to steel | hardening agent to | |
| | sheet | organic substance or | |
| | | inorganic substance | |
| film forming- | rapid reaction to | slow hardening | high dependence on |
| mechanism | steel sheet, | reaction, As | temperature |
| | dehydration/ | temperature is high, | |
| | condensation | hardening density of | |
| | reaction, low | film is increased. | |
| | dependence on | | |
| | temperature | | |
| corrosion preven- | anodic reaction | impermeable barrier | |
| tionmechanism | prevention | formed for corrosion | |
| | | current | |
| dry film thickness | 10~100 mg/m² | 300~700 mg/m² | |
| wet film thickness | 1~2 □ | 3~5 □ | heat needed |
| solution costs | low | high (small quantity | decreased if mass |
| | | needed) | produced |

At present, a large amount of chrome is contained in a resin-coated steel sheet which is used for a fuel tank of vehicle. But, the RoHS (Restriction on the use of Certain Hazardous Substances in Electrical and Electronic Equipment) directive prescribes that stating from July, 2006 electrical and/or electronic devices may be sold only if they are almost free of the prohibited materials including chrome. And, the use of chrome will be fully regulated from June, 2007. Accordingly, measures to develop a Cr-free steel sheet for use in a fuel tank are urgently needed.

### DISCLOSURE OF INVENTION

### Technical Problem

Therefore, the present invention has been made in view of the above problems, and it is an object of the present invention to provide a surface treated Cr-free steel sheet for use in a fuel tank which does not contain chrome and has high adhesive properties, corrosion resistance, fuel resistance and weldability.

It is another object of the present invention to provide a method for manufacturing a surface treated Cr-free steel sheet for use in a fuel tank which does not contain chrome and has high adhesive properties, corrosion resistance, fuel resistance and weldability.

It is yet another object of the present invention to provide Cr-free treatment liquid and resin treatment liquid which are used for manufacturing a surface treated steel sheet.

### Technical Solution

In accordance with an aspect of the present invention, the above and other objects can be accomplished by the provision of a surface treated Cr-free steel sheet for use in a fuel tank comprising: a Zn-based electroplated steel sheet; a Cr-free layer which is formed by a Cr-free treatment liquid coated on the Zn-based electroplated steel sheet, the Cr-free treatment liquid containing silicate of 3 to 40 parts by weight, silane of 0.5 to 10 parts by weight, titanium compound of 0.2 to 8 parts by weight, binder resin of 10 to 50 parts by weight, the binder resin being selected from the group consisting of urethane resin, epoxy resin and a combination thereof, and phosphoric ester of 1 to 5 parts by weight based on the Cr-free treatment liquid of 100 parts by weight; and a resin layer which is formed by a water-based resin treatment liquid coated on the Cr-free layer, the resin treatment liquid containing melamine resin of 3 to 25 parts by weight, colloidal silica of 10 to 20 parts by weight, metal powder of 5 to 40 parts by weight, and phosphoric ester of 1 to 5 parts by weight based on phenoxy resin of 100 parts by weight.

In accordance with another aspect of the present invention, a method for manufacturing a surface treated Cr-free steel sheet for use in a fuel tank comprises the steps of: coating a Cr-free treatment liquid on a Zn-based electroplated steel sheet, the Cr-free treatment liquid containing silicate of 3 to 40 parts by weight, silane of 0.5 to 10 parts by weight, titanium compound of 0.2 to 8 parts by weight, binder resin of 10 to 50 parts by weight, the binder resin being selected from the group consisting of urethane resin, epoxy resin and a combination thereof, and phosphoric ester of 1 to 5 pails by weight based on the Cr-free treatment liquid of 100 pairs by weight; forming a Cr-free layer by baking the steel sheet coated with the Cr-free treatment liquid at a metal temperature of 160 to 250° C.; coating a water-based resin treatment liquid on the Cr-free layer formed on the steel sheet, the resin treatment liquid containing melamine resin of 3 to 25 parts by weight, colloidal silica of 10 to 20 parts by weight, metal powder of 5 to 40 parts by weight, and phosphoric ester of 1 to 5 parts by weight based on phenoxy resin of 100 parts by weight; and forming a resin layer by baking the steel sheet coated with the resin treatment liquid at a metal temperature of 190 to 250° C.

In accordance with a further aspect of the present invention, a Cr-free treatment liquid comprises: silicate of 3 to 40 parts by weight; silane of 0.5 to 10 parts by weight; titanium compound of 0.2 to 8 parts by weight; binder resin of 10 to 50 parts by weight, the binder resin being selected from the group consisting of urethane resin, epoxy resin and a combination thereof; and phosphoric ester of 1 to 5 parts by weight, based on the Cr-free treatment liquid of 1100 parts by weight.

In accordance with yet another aspect of the present invention, a resin treatment liquid comprises: melamine resin of 3 to 25 parts by weight; colloidal silica of 10 to 20 parts by weight; metal powder of 5 to 40 parts by weight; and phosphoric ester of 1 to 5 parts by weight, based on phenoxy resin of 100 parts by weight.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating mechanism that adhesiveness of a plated steel sheet and a resin layer is improved by phosphoric ester and silane in a Cr-free layer; and

FIG. 2 is a view showing a device which is used to evaluate fuel resistance of a Cr-free steel sheet in accordance with the present invention.

### BEST MODE FOR CARRYING OUT THE INVENTION

Preferred embodiments of the present invention will now be described in detail with reference to the annexed drawings.

A surface treated Cr-free steel sheet for use in a fuel tank according to the present invention, which does not contain chrome and has high adhesive properties, corrosion resistance, fuel resistance and weldability, includes a Cr-free layer which is formed on a zinc-based electroplated steel sheet and a resin layer which is formed on the Cr-free layer.

In a surface treated Cr-free steel sheet for use in a fuel tank according to the present invention, a substrate steel sheet may be configured as a zinc-based electroplated steel sheet which is made by electroplating zinc (Zn) on a cold rolled steel sheet, or a zinc-nickel (Zn—Ni) electroplated steel sheet which is made by electroplating Zn—Ni alloy on a cold rolled steel sheet. It is more preferable to use the Zn—Ni electroplated steel sheet rather than the zinc-based electroplated steel sheet. This is because the Zn—Ni electroplated steel sheet has higher corrosion resistance. It is preferred that plating amount of Zn or Zn—Ni in the zinc-based electroplated steel sheet or the Zn—Ni electroplated steel sheet is in the range of 20 to 30 g/m². If the plating amount is less than 20 g/m², there is problem that a sacrificial protection effect decreases. If the plating amount is over 30 g/m², there is problem that productivity decreases.

The steel sheet for use in a fuel tank according to the present invention has a Cr-free layer on the substrate steel sheet. The Cr-free layer is formed by coating Cr-free treatment liquid and bake drying the same. The Cr-free treatment liquid is generally classified into reaction type treatment liquid and coating type treatment liquid. It is more preferable to use the coating type treatment liquid, which has high corrosion resistance.

The Cr-free treatment liquid used for forming the Cr-free layer may be made by combining silicate, silane and titanium compound as main materials and urethane resin and phosphoric ester for improving the properties of a film, into water. Also, a wetting agent and a defoaming agent may be further added as needed. In the Cr-free treatment liquid, silicate, silane, titanium compound, urethane resin and phosphoric ester are in state of being dispersed in the water. The Cr-free treatment liquid is comprised of water in addition to the aforesaid components.

Silicate may be configured as NaSiO₃ and/or NaSi₅O₁₁. When coated on the steel sheet, silicate forms a three-dimensional net-shaped structure and has a high binding force with the underlying substrate steel sheet (the plated steel sheet). Silicate may be used in amount of 3 to 40 parts by weight based on 100 parts by weight of the Cr-free treatment liquid. If the content of silicate is too low, less than 3 parts by weight, the adhering force with the steel sheet and the corrosion resistance decreases. On the other hand, if the content of silicate is over 40 parts by weight, the binding force with the resin decreases.

Silane is hydrolyzed in the water and forms siloxide linkage. Silane is strongly bound to the steel sheet by the siloxide linkage, and functions as a binding which combines various inorganic substances. It is preferable to use gamma (γ) glycidoxypropyltriethoxy silane and/or gamma (γ) aminopropyltriethoxy silane, which is easily hydrolyzed, as silane for use in the Cr-free treatment liquid, however, this is not restricted thereto.

Also, the KBM series manufactured by Shin-Etsu Chemical Co., Ltd. may be used as silane. Silane may be used in amount of 0.5 to 10 parts by weight based on 100 parts by weight of the Cr-free treatment liquid. If the content of silane is too low, less than 0.5 parts by weight, the adhering force with the steel sheet and the corrosion resistance decreases. On the other hand, if the content of silane is over 10 parts by weight, the properties of the substance is the same as that when the content is lower than 10 parts by weight, but it is not economical.

The titanium compound has a function of improving corrosion resistance by the reaction with the plated layer, particularly, the Zn plated layer or the Zn—Ni plated layer, on the substrate steel sheet. Amine neutralized hexafluoro titanic acid may be used as the titanium compound for use in the Cr-free treatment liquid, however this is not restricted thereto. In other words, hexafluoro titanic acid is neutralized by amine to an extent of becoming basic of pH 9˜10, and then put into the Cr-free treatment liquid. Triethylamine may be used as amine. If the hexafluoro titanic acid is not adjusted to pH 9˜10, it may be gelled.

The titanium compound may be used in amount of 0.2 to 8.0 parts by weight based on 100 parts by weight of the Cr-free treatment liquid. If the content of the titanium compound is less than 0.2 parts by weight, the corrosion resistance effect is deteriorated. If the content is over 8.0 parts by weight, since the further improvement of the properties of the substance cannot be achieved, it is not economical.

Silicate, silane and the titanium compound are mixed, and used as main materials of the Cr-free treatment liquid. Subsequently, in order to improve the adhesiveness, binder resin having a high adhering force and phosphoric ester are added to the above main materials. This is for maintaining the stability of Cr-free treatment liquid from the subsequent addition of additives such as the binder resin and the phosphoric ester by mixing silicate with silane to react to each other in advance. The respective components in the Cr-free treatment liquid are prepared by being mixed in the water.

As the binder resin for binding the inorganic substances like silicate, silane and the titanium compound, urethane resin, epoxy resin or a combination thereof, which has a high binding force with the steel sheet, may be added to the Cr-free treatment liquid. Because the epoxy resin reacts to the steel sheet, functions to bind the inorganic additives and has soft properties, the urethane resin is adequate for the binder resin. Because the epoxy resin contains hydroxyl group in the resin molecule, the hydroxyl group reacts to the steel sheet, and the remaining reactive groups function to bind the above inorganic additives. Similarly to the epoxy resin, the urethane resin reacts to the steel sheet, functions to bind the inorganic additives, and has soft properties. Accordingly, the urethane resin is adequate for the binder resin.

It is preferred that a binder resin having a number average molecular weight of 1,000 or more is used. The upper limit value of the number average molecular weight is not restricted especially, however the binder resin generally has a maximum number average molecular weight of about 7,000. Therefore, the binder resin having a number average molecular weight of about 1,000 to 7,000 may be used. The binder resin may be used in amount of 10 to 50 parts by weight based on 100 parts by weight of the Cr-free treatment liquid. If the content of the binder resin is less than 10 parts by weight, the adhesiveness to the steel sheet and the force of binding the inorganic additives are not sufficient. If the content is over 50 parts by weight, the corrosion resistance is decreased.

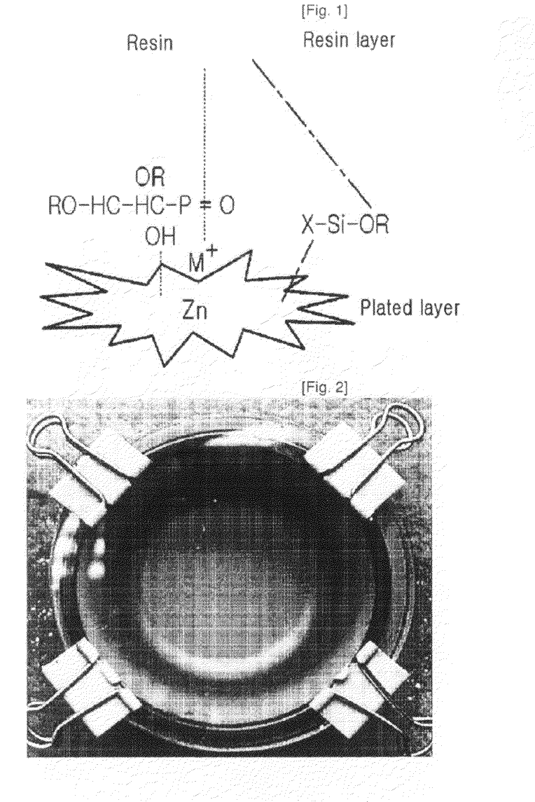

Phosphoric-ester is used for increasing the adhesiveness of the steel sheet and the Cr-free layer and the adhesiveness of the steel sheet and the resin layer. The mechanism that the adhesiveness of the steel sheet and the Cr-free layer and the adhesiveness of the steel sheet and the resin layer are increased by the phosphoric-ester is illustrated in FIG. 1. In order to increase the adhesiveness, a multiple binding structure is formed at the respective interfaces. As shown by a dotted line in FIG. 1, the phosphoric-ester of the Cr-free layer reacts to functional group of the resin of the resin layer, and at the same time is bound to the plated layer, particularly the Zn plated layer or the Zn—Ni plated layer, on the substrate steel sheet. As shown by a dashed dotted line in FIG. 1, silane of the Cr-free layer reacts to the functional group of the resin, and at the same time, reacts to the plated layer, particularly, the Zn plated layer or the Zn—Ni plated layer, on the substrate steel sheet, so that the Cr-free layer is bound in double to the overlaid resin layer and the underlaid plated layer. Accordingly, the adhesiveness of the steel sheet and the resin layer is increased by the Cr-free layer.

Phosphoric-ester may be used in amount of 1.0 to 5.0 parts by weight based on 100 parts by weight of the Cr-free treatment liquid. If the content of phosphoric-ester is less than 1.0 parts by weight, sufficient adhesiveness of the steel sheet and the overlaid resin layer is not achieved. If the content is over 5.0 parts by weight, the further effect resulting from the increase of the content is not achieved.

The Cr-free layer is formed by coating the Cr-free treatment liquid on the plated steel sheet and baking the same.

The Cr-free treatment liquid is coated such that the dry film coating amount onto one surface of the plated steel sheet is in the range of 500 to 1,000 mg/m². If the coating amount is less than 500 mg/m², it is difficult to achieve the sufficient corrosion resistance and fuel resistance. If the coating amount is over 1,000 mg/m², the adhesiveness to the overlaid resin layer and the weldability deteriorate.

After coating the Cr-free treatment liquid, the baking process is performed at a temperature of 160 to 250° C. based on the metal temperature. If the baking temperature is less than 160° C., the reaction between the resin and the inorganic substances is not sufficient, and so when washing, a part of the components is left off, thereby making it difficult to achieve the desired corrosion resistance. If the baking temperature is over 250° C., the hardening reaction is generated no more, and heat loss is increased as much.

The Cr-free layer may be coated on one or the both surfaces of the substrate steel sheet (plated steel sheet). The Cr-free layer can be coated on the steel sheet by using several coating methods, such as a roll coating method, a spray method, a dip method, etc. Of the above coating methods, the roll coating method is most preferable, because the Cr-free treatment liquid can be easily coated on one or both surfaces of the steel sheet by the roll coating method.

In the process of coating the Cr-free treatment liquid, for example, a pickup roll is stained with a solution provided in a drip pan and transfers the solution to a transfer roll, and an applicator roll coats the solution on the plated steel sheet. The plated steel sheet coated with the solution is dried in an oven to completely form the film. By the above process, the Cr-free layer is formed on the plated steel sheet. The coating amount of the Cr-free treatment liquid depends on driving directions, rotational speeds and contact pressures of the rolls.

After forming the Cr-free layer on the plated steel sheet, the resin layer is formed on the Cr-free layer. Because the resin layer has a function of improving the adhesiveness and making the film tough, the high corrosion resistance can be achieved.

The resin treatment liquid is a water-based treatment liquid which contains phenoxy resin as main material. The resin treatment liquid further contains melamine resin, silica, metal powder and phosphoric ester, in order to improve the properties of the steel sheet. The water-based resin treatment liquid may further contain additives as needed, like a defoaming agent or a wetting agent, which are generally used for manufacturing the resin treatment liquid in this alt.

The phenoxy resin, which has high corrosion resistance and fuel resistance, is used as the main material of the resin treatment liquid for forming the overlaid resin layer. In addition to high corrosion resistance and fuel resistance, the phenoxy resin has different physical features from other resins. The main physical feature of the phenoxy resin over other resins is a high glass transition temperature. The high glass transition temperature means that the temperature at which resin chains move is high. At the temperature under the glass transition temperature, the resin chains do not perform a micro brownian motion and are kept in a stationary state, so as to show a primary defense effect against exterior low-molecular corrosion factors, e.g., water or volatile oil. If the resin chains perform a micro brownian motion, the low molecular corrosion factors easily penetrate between the moving chains. In other words, the phenoxy resin having the glass transition temperature of about 100° C. has a considerable effect of shielding the substrate steel sheet.

It is preferred that the phenoxy resin having a number average molecular weight of 25,000 to 50,000 is used. If the number average molecular weight is less than 25,000, it is difficult to secure the desired properties of substance. If the number average molecular weight is over 50,000, it is impossible to synthesize the resin due to limitations of the resin synthesizing method.

Meanwhile, the phenoxy resin is used in manufacturing the resin treatment liquid in the state of dissolving and being dispersed in water.

The resin treatment liquid may contain the melamine resin in amount of 3 to 25 pairs by weight as a hardening agent based on 100 pairs by weight of the phenoxy resin. It is preferable to choose the melamine resin having a good reactivity. For example, the Cymel 325 may be used as the melamine resin, however, this is not restricted thereto. If the content of the melamine resin is less than 3 parts by weight, the hardening reaction is not perfectly achieved after the resin coating, and thus the metal powder fixing effect is decreased. If the content of the melamine resin is over 25 parts by weight, a reaction between the hardening agents is generated due to the excessive addition of the melamine resin, thereby exerting a bad influence on the properties of the film.

Also, in order to improve the corrosion resistance of the resin film, the resin treatment liquid may further contain colloidal silica in amount of 10 to 20 parts by weight based on 100 parts by weight of the phenoxy resin. If the content of colloidal silica is less than 10 parts by weight, the sufficient corrosion resistance cannot be acquired. Although the content of colloidal silica is over 20 parts by weight, the corrosion resistance increases no more.

The phenoxy resin has an advantage of high corrosion resistance and fuel resistance, but has a disadvantage of low weldability due to the resin thickness. In order to solve this problem, the metal powder is added into the resin treatment liquid. The metal powder may be selected from the group consisting of Ni, Zn, Al, Cu, SnO and a mixture thereof.

It is preferred that the metal powder having the particle diameter of 0.5 to 1.0□ is used. The lower limit value of the particle diameter of the metal powder is determined by the limitation in manufacturing the metal powder. If the particle diameter of the metal powder is over 1.0□, the specific gravity is increased, and the metal powder is deposited in the resin solution, which causes a problem of storage of the solution. The metal powder having the plate shape is more useful than the metal powder having the ball shape (however, this is not restricted thereto). This is because the more buoyancy is exerted on the plate-shaped metal powder than the ball-shaped metal powder, so that the plate-shaped metal powder can float on the solution for a longer time.

It is more preferable to use the SnO powder, because SnO has the smaller specific gravity and particle diameter than other metals described above. In addition, the SnO powder has the features of being easily dispersed in the resin solution and having high weldability with the low content.

The resin treatment liquid may contain the metal powder in amount of 5 to 40 parts by weight based on 100 parts by weight of the phenoxy resin. As the content of the metal powder is low, especially, less than 5 parts by weight, the weldability is considerably low. As the content of the metal powder is high, especially, over 40 parts by weight, the cohesive power of the resin decreases, and the adhesiveness to the steel sheet also decreases.

Further, in order to enhance the adhesiveness of the resin solution and the steel sheet, phosphoric-ester may be added in amount of 1.0 to 5.0 parts by weight based on 100 parts by weight of the resin treatment liquid. If the content of phosphoric-ester is less than 1.0 parts by weight, the adhesiveness of the steel sheet and the overlaid resin layer deteriorates. If the content of phosphoric-ester is over 5.0 parts by weight, the further effect resulting from the increase of the content is not achieved.

The resin treatment liquid is the water-based treatment liquid, which contains water besides the aforesaid components. The resin treatment liquid contains the solid of 30 to 50 wt % and water of 50 to 70 wt %. If the content of the solid is less than 30 wt %, it is difficult to form the firm film, and so the adhering force between the Cr-free layer and the steel sheet decreases. If the content of the solid is over 50 wt %, the viscosity is increased, and the coating process cannot be performed smoothly.

The resin layer is formed by coating the resin treatment liquid containing melamine resin, silica, metal powder and phosphoric-ester onto the Cr-free layer and baking the same. The resin layer may be formed on one or both surfaces of the Cr-free layer as needed.

The resin layer is coated such that the dry film thickness becomes 2.0 to 10.0□. If the film thickness is less than 2□, the film thickness is too thin to secure the sufficient corrosion resistance and fuel resistance. Although the film thickness is over 10□, the corrosion resistance and the fuel resistance improve no more, and the weldability of the steel sheet deteriorates (although the resin film contains the metal powder).

After the resin coating, the baking process is performed at the temperature of 190 to 250° C. based on the metal temperature. If the baking temperature is less than 190° C., the hardening reaction of the resin is not sufficient, and so the fixing force between the metal powder and the resin decreases. If the baking temperature is over 250° C., the hardening reaction is generated no more, and heat loss increases as much.

The resin treatment liquid can be coated on the steel sheet by using several coating methods, such as a roll coating method, a spray method, a dip method, etc. Of the above coating methods, the roll coating method is most preferable, because the roll coating method can be applied to one or both surfaces of the Cr-free layer.

Similarly to the Cr-free layer, the resin layer is formed in a process of for example a pickup roll is stained with a solution provided in a drip pan and transfers the solution to a transfer roll and an applicator roll coats the solution on the plated steel sheet. The plated steel sheet coated with the solution is dried in an oven to completely form the resin layer on the Cr-free layer. The dry film thickness of the resin layer depends on driving directions, rotational speeds and contact pressures of the rolls.

The resin treatment liquid for providing functionality may be coated on one or both surfaces of the Cr-free layer according to the purpose or the client company's demands. This is because the welding conditions of client companies are respectively different. For example, in the case of the client company which adopts the welding condition of using high current and replacing electrodes frequently, the resin layer can be formed on the both surfaces of the Cr-free layer. However, in the case of the client company which adopts the welding condition of using low current and replacing electrodes infrequently, it is preferable to use the steel sheet in which the resin layer is formed on one surface of the Cr-free layer.

When manufacturing a fuel tank with the steel sheet having the resin layer on one surface, the surface coated with the resin is the surface in contact with the fuel, and the Cr-free layer on the opposite surface is in contact with the outside. Accordingly, when welding the steel sheet, because the portions where the resins do not contact each other are welded, the welding process can be performed more easily.

In order to reinforce the corrosion resistance of the fuel tank, because a thick top coating (about 100□) is generally applied to the Cr-free layer where the resin layer is not formed, no influence is exerted on the corrosion resistance.

As described above, the present invention provides the steel sheet which includes the Zn-based or Zn alloy electroplated steel sheet which does not contain Cr, the Cr-free layer formed on the electroplated steel sheet, and the resin layer formed on the Cr-free layer. The steel sheet according to the present invention has high adhesiveness, corrosion resistance, fuel resistance and weldability, and is adequate for use in the fuel tank for vehicle.

Hereinafter, reference will be made in detail to the preferred examples of the present invention. The present invention may, however, be embodied in many alternate forms and should not be construed as limited to the examples set forth herein.

### Example 1

In this example, the properties of the steel sheet are evaluated according to the composition variation of the Cr-free treatment liquid.

The Cr-free treatment liquid, which contains silicate, silane, titanium compound, urethane resin having a number average molecular weight of 1,500, and phosphoric ester, is roll-coated on the both surfaces of the Zn electroplated steel sheet which is made by plating the cold rolled steel sheet with Zn by the plating amount of 30 g/m². At this time, the dry film coating amount of the Cr-free treatment liquid onto one surface of the steel sheet is 700 mg/m². The steel sheet coated with the Cr-free treatment liquid is baked at the temperature of 190° C. and cooled. The contents of silicate, silane, titanium compound, urethane resin, and phosphoric ester in the Cr-free treatment liquid are changed as the following table 2. Hexafluoro titanic acid, which is adjusted to an extent of pH 9 by using triethylamine, is used as the titanium compound. The Cr-free treatment liquid is made by mixing the components in water in amount described in the following table 2 based on 100 parts by weight of the Cr-free treatment liquid.

When preparing the Cr-free treatment liquid, silicate, silane and titanium compound are firstly mixed, and then urethane resin and phosphoric ester are added.

The evaluation results of the quality of the steel sheet according to this example are shown in the following table 2. The qualitative evaluation items are corrosion resistance and adhesiveness, which are necessary to the steel sheet for use in a fuel tank.

[Evaluation of Corrosion Resistance]

In the case of steel sheet coated only with the Cr-free treatment liquid (example 1), the corrosion resistance is evaluated by the percentage of rust generated after the elapse of 500 hours under the conditions of 5 wt % of brine, the temperature of 35° C. and the spray pressure of 1 kg/cm². In the case of steel sheet coated with the Cr-free treatment liquid and the resin (examples 2 to 4), the corrosion resistance is evaluated by the percentage of rust generated after the elapse of 1,000 hours under the same conditions as the above. The evaluation references are as follows.

⊚: corrosion area is 0%

∘: corrosion area is less than 5%

□: corrosion area is 5 to 30%

Δ: corrosion area is 30 to 50%

x: corrosion area is more than 50%

[Evaluation of Adhesiveness]

The resin adhesiveness of the steel sheet is evaluated by two methods, one of which is the adhesiveness evaluation after boiling, and the other of which is the adhesiveness evaluation after cup forming. In the adhesiveness evaluation method after boiling, the steel sheet is boiled in boiling water for 30 minutes, and pulled out of the water to be air dried for 5 minutes. Then, an adhesive tape is stuck to the steel sheet and removed from the steel sheet. The adhesiveness is evaluated by the exfoliated area. When the adhesiveness is graded 1 (the exfoliated area is 0 to 5%), the product can pass the inspection. The evaluation references are as follows.

⊚: exfoliated area is 0 to 5%

∘: exfoliated area is 5 to 20%

□: exfoliated area is 20 to 50%

Δ: exfoliated area is 50 to 75%

x: exfoliated area is 75 to 100%

In the adhesiveness evaluation method after cup forming, the steel sheet is punched with Φ95, and deformed as cup-shape with a radius of curvature of R4 and a height of 25 mm. Then, an adhesive tape is stuck to the wall-side of the cup and removed from the wall-side of the cup. The adhesiveness is evaluated by the exfoliated area. When the adhesiveness is graded 1 (the exfoliated area is 0 to 5%), the product can pass the inspection. The evaluation references are as follows.

⊚: exfoliated area is 0 to 5%

∘: exfoliated area is 5 to 20%

□: exfoliated area is 20 to 50%

Δ: exfoliated area is 50 to 75%

x: exfoliated area is 75 to 100%

TABLE 2

| | composition (based on Cr-free liquid | | | | | | | |
|---|---|---|---|---|---|---|---|---|
| | of 100 parts by weight) | | | | | | | |
| | | | titanium | urethane | phosphoric | quality evaluation results | | |
| | silicate | silane | compound | resin | ester | | adhesiveness | |
| | (parts by | (parts by | (parts by | (parts by | (parts by | corrosion | after | after cup- |
| examples | weight) | weight) | weight) | weight) | weight) | resistance | boiling | forming |
| Comparative | 1 | 3 | 3 | 20 | 2 | □ | Δ | □ |
| inventive | 3 | | | | | ◯ | ◯ | ◯ |
| inventive | 20 | | | | | ⊚ | ⊚ | ⊚ |
| inventive | 40 | | | | | ⊚ | ⊚ | ⊚ |
| Comparative | 50 | | | | | ⊚ | ◯ | □ |
| Comparative | 20 | 0.3 | | | | Δ | □ | ◯ |
| inventive | | 0.5 | | | | ◯ | ◯ | ◯ |
| inventive | | 3 | | | | ⊚ | ⊚ | ⊚ |
| inventive | | 10 | | | | ⊚ | ⊚ | ⊚ |
| Comparative | | 15 | | | | ⊚ | ⊚ | ⊚ |
| Comparative | | 3 | 0.1 | | | □ | ⊚ | ⊚ |
| inventive | | | 0.2 | | | ◯ | ⊚ | ⊚ |
| inventive | | | 3 | | | ⊚ | ⊚ | ⊚ |
| inventive | | | 5 | | | ⊚ | ⊚ | ⊚ |
| inventive | | | 8 | | | ⊚ | ⊚ | ⊚ |
| Comparative | | | 10 | | | ⊚ | ⊚ | ⊚ |
| Comparative | | | 3 | 5 | | Δ | □ | □ |
| inventive | | | | 10 | | ◯ | ◯ | ⊚ |
| inventive | | | | 20 | | ⊚ | ⊚ | ⊚ |
| inventive | | | | 50 | | ◯ | ⊚ | ⊚ |
| Comparative | | | | 60 | | □ | ⊚ | ⊚ |
| Comparative | | | | 20 | 0.5 | ◯ | □ | □ |
| inventive | | | | | 1.0 | ⊚ | ⊚ | ⊚ |
| inventive | | | | | 2 | ⊚ | ⊚ | ⊚ |
| inventive | | | | | 5 | ⊚ | ⊚ | ⊚ |
| Comparative | | | | | 8 | ⊚ | ⊚ | ⊚ |

As seen from the above table 2, the steel sheet coated with the Cr-free treatment liquid, whose components are mixed with the predetermined contents in accordance with the present invention, has high corrosion resistance and adhesiveness. In the above table 2, the respective samples containing silane of 15 parts by weight, titanium compound of 10 parts by weight and phosphoric ester of 8 parts by weight have good properties, but they are not economical because a large amount of components are used.

### Example 2

In this example, the properties of the steel sheet are evaluated according to the forming conditions of the Cr-free treatment liquid.

The Cr-free layer is formed on the Zn electroplated steel sheet having the plating amount of 30 g/m². The dry film coating amount of the Cr-free solution and the baking temperature are changed as described in the following table 3. The Cr-free treatment liquid contains silicate of 20 parts by weight, silane of 2 parts by weight, titanium compound 1 parts by weight, urethane resin of 20 parts by weight and phosphoric ester of 3 parts by weight based on 100 parts by weight of the Cr-free treatment liquid, and the above components are mixed in water. When preparing the Cr-free treatment liquid, silicate, silane and titanium compound are first mixed, and then urethane resin and phosphoric ester are added.

The Cr-free layer is formed by coating the above Cr-free treatment liquid on the both surfaces of the steel sheet with the dry film coating amount described in the following table 3 by a roll coating method and baking the same at the baking temperature described in the following table 3. Urethane resin having a number average molecular weight of 1,500 is used. And, hexafluoro titanic acid, which is adjusted to an extent of pH 9 by using triethylamine, is used as the titanium compound.

After the Cr-free layer is formed, the resin layer is formed on one surface of the Cr-free layer. The resin layer has a thickness of 3□, and is bake-dried at the temperature of 200° C.

The resin treatment liquid contains melamine resin of 5 parts by weight, colloidal silica of 15 parts by weight (which has a mean particle diameter of 20 nm), ball-shaped SnO powder of 30 parts by weight (which has a mean particle diameter of 0.5□) and phosphoric ester of 3 parts by weight based on the phenoxy resin of 100 parts by weight (which has a number average molecular weight of 50,000). The above components are sequentially added to the phenoxy resin which is dispersed in water.

The resin treatment liquid is adjusted such that the content of the solid becomes 30 wt % by using water.

The evaluation results of the quality of the steel sheet according to this example are shown in the following table 3. The qualitative evaluation items are corrosion resistance, adhesiveness and weldability, which are necessary to the steel sheet for use in a fuel tank. The evaluation conditions of the corrosion resistance and the adhesiveness are the same as those of the first embodiment.

[Evaluation of Weldability]

Firstly, the steel sheet is welded by using a pneumatic AC spot welding machine at a pressing force of 250 kgf, a welding time of 15 cycles and electric current of 7.5 kA. The weldability is evaluated by whether spatter is generated and whether the welded portion is broken off when holding the steel sheet by a nipper and twisting the same.

If the spatter is not generated and the welded portion is not broken off, the weldability is evaluated to be good (which is marked by “⊚” in the following table 3). Otherwise, the weldability is evaluated to be bad (which is marked by “x” in the following table 3).

TABLE 3

| | manufacturing | | | | | |
|---|---|---|---|---|---|---|
| | conditions | | quality evaluation results | | | |
| | | coating | | | adhesiveness | |
| | baking temp. | amount | corrosion | adhesiveness | after | |
| examples | (° C.) | (mg/m²) | resistance | after boiling | cup-forming | weldability |
| Comparative | 150 | 500 | □ | Δ | Δ | ⊚ |
| inventive | 160 | | ◯ | ⊚ | ◯ | ⊚ |
| inventive | 210 | | ⊚ | ⊚ | ⊚ | ⊚ |
| inventive | 250 | | ⊚ | ⊚ | ⊚ | ⊚ |
| Comparative | 260 | | ⊚ | ⊚ | ⊚ | ⊚ |
| Comparative | 190 | 100 | X | ⊚ | □ | ⊚ |
| Comparative | | 200 | Δ | ⊚ | ◯ | ⊚ |
| inventive | | 500 | ⊚ | ⊚ | ⊚ | ⊚ |
| inventive | | 1000 | ⊚ | ⊚ | ⊚ | ⊚ |
| Comparative | | 1300 | ⊚ | ⊚ | ◯ | X |

In the table 3, the comparative example having the baking temperature condition of 260° C. has shortcoming of high manufacturing costs due to high baking temperature.

### Example 3

In this example, the properties of the steel sheet are evaluated according to the composition variation of the resin solution.

The Cr-free treatment liquid is roll-coated on the both surfaces of the Zn—Ni electroplated steel sheet having the plating amount of 30 g/m². The Cr-free treatment liquid contains silicate of 20 parts by weight, silane of 2 parts by weight, titanium compound 1 parts by weight, urethane resin of 20 pairs by weight (which has a number average molecular weight of 2,000), and phosphoric ester of 3 parts by weight based on the Cr-free treatment liquid of 100 parts by weight. The above components are mixed in water. At this time, the dry film coating amount of the Cr-free treatment liquid onto one surface of the steel sheet is 600 mg/m². The steel sheet coated with the Cr-free treatment liquid is baked at the temperature of 190° C. and cooled by air. When preparing the Cr-free treatment liquid, silicate, silane and titanium compound are first mixed, and then urethane resin and phosphoric ester are added.

Afterwards, the resin treatment liquid is coated on the both surfaces of the Cr-free layer such that the dry film thickness becomes 2□, and bake-dried at the temperature of 190° C. Hexafluoro titanic acid, which is adjusted to an extent of pH 9 by using triethylamine, is used as the titanium compound.

The resin treatment liquid forming the resin layer contains melamine resin, colloidal silica (which has a mean particle diameter of 20 nm), ball-shaped metal powder and phosphoric ester. The above components are sequentially added to the phenoxy resin which is dispersed in water, while changing the contents of the above components based on the phenoxy resin of 100 parts by weight which has a number average molecular weight of 50,000 (refer to the following table 4).

The resin treatment liquid is adjusted such that the content of the solid becomes 30 wt % by using water.

The evaluation results of the quality of the steel sheet according to this example are shown in the following table 4. The qualitative evaluation items are corrosion resistance, adhesiveness, weldability, solution stability and fuel resistance which are necessary to the steel sheet for use in a fuel tank. The evaluation conditions of the corrosion resistance and the adhesiveness are the same as those of the example 1, and the evaluation conditions of the weldability are the same as those of the example 2.

[Evaluation of Solution Stability]

The resin treatment liquid is poured into a mass cylinder having a height of 250 mm by 200 mm. The solution stability is evaluated by a thickness of metal powder which is deposited in the mess cylinder after 8 hours have elapsed. If the metal powder thickness is over 5 mm, the solution stability is evaluated to be insufficient (which is marked by “x” in the following table 4). If the metal powder thickness is less than 5 mm, the solution stability is evaluated to be sufficient (which is marked by “⊚” in the following table 4).

[Evaluation of Fuel Resistance]

The fuel resistance of the steel sheet is evaluated by two methods. One method is that gasoline is poured into a cup specimen of a device shown in FIG. 2 by 25 ml and left at a normal temperature. The fuel resistance is evaluated by a corrosion area generated after 6 months have elapsed. The other method is a so-called “gasoline deterioration evaluation method”. The test process is the same as that of the above evaluation method, except that 5% NaCl solution is added to the gasoline of 24 ml by 1 ml. The gasoline deterioration evaluation method is adopted in this example to evaluate the fuel resistance. The evaluation references are as follows.

⊚: corrosion area is 0%

∘: corrosion area is less than 5%

□: corrosion area is 5 to 30%

Δ: corrosion area is 30 to 50%

x: corrosion area is more than 50%

TABLE 4

| | solution composition | | | | | | | | | | |
|---|---|---|---|---|---|---|---|---|---|---|---|
| | | | metal powder | | phosphoric | quality evaluation results | | | | | |
| | melamine | silica | SnO | Zn | ester | | | | adhesiveness | | |
| | (Parts | (Parts | (particle | (particle | (parts | | | | | after | |
| | by | by | diameter, | diameter, | by | solution | corrosion | fuel | after | cup- | weld- |
| examples | weight) | weight) | μm) | μm) | weight) | stability | resistance | resistance | boiling | forming | ability |
| Comparative | 1 | 15 | 10 | — | 3 | ⊚ | ◯ | ◯ | Δ | □ | ⊚ |
| inventive | 3 | | | | | ⊚ | ◯ | ◯ | ◯ | ◯ | ⊚ |
| inventive | 7 | | | | | ⊚ | ⊚ | ⊚ | ⊚ | ⊚ | ⊚ |
| inventive | 25 | | | | | ⊚ | ⊚ | ⊚ | ⊚ | ⊚ | ⊚ |
| Comparative | 30 | | | | | ⊚ | □ | ⊚ | ◯ | ⊚ | ⊚ |
| Comparative | 7 | 5 | | | | ⊚ | Δ | □ | □ | ◯ | ⊚ |
| inventive | | 10 | | | | ⊚ | ◯ | ⊚ | ◯ | ◯ | ⊚ |
| inventive | | 15 | | | | ⊚ | ⊚ | ⊚ | ⊚ | ⊚ | ⊚ |
| inventive | | 20 | | | | ⊚ | ⊚ | ⊚ | ⊚ | ⊚ | ⊚ |
| inventive | | 25 | | | | ⊚ | ⊚ | ⊚ | ⊚ | ⊚ | ⊚ |
| Comparative | | 15 | 3 (0.5) | | | ⊚ | ⊚ | ⊚ | ⊚ | ⊚ | X |
| Comparative | | | 5 (0.5) | | | ⊚ | ⊚ | ⊚ | ⊚ | ⊚ | ⊚ |
| Comparative | | | 10 (0.5) | | | ⊚ | ⊚ | ⊚ | ⊚ | ⊚ | ⊚ |
| inventive | | | 30 (0.5) | | | ⊚ | ⊚ | ⊚ | ⊚ | ⊚ | ⊚ |
| inventive | | | 40 (0.5) | | | ⊚ | ⊚ | ⊚ | ⊚ | ⊚ | ⊚ |
| inventive | | | 50 (0.5) | | | ⊚ | ⊚ | ⊚ | ⊚ | □ | ⊚ |
| Comparative | | | 10 (1.5) | | | X | ⊚ | ⊚ | ⊚ | ⊚ | ⊚ |
| Comparative | | | — | 3 (1.5) | | X | ⊚ | ⊚ | ⊚ | ⊚ | X |
| Comparative | | | | 5 (1.5) | | X | ⊚ | ⊚ | ⊚ | ⊚ | ⊚ |
| Comparative | | | | 10 (1.5) | | X | ⊚ | ⊚ | ⊚ | ⊚ | ⊚ |
| Comparative | | | | 30 (1.5) | | X | ⊚ | ⊚ | ⊚ | ⊚ | ⊚ |
| Comparative | | | | 40 (1.5) | | X | ⊚ | ⊚ | ⊚ | ⊚ | ⊚ |
| Comparative | | | | 50 (1.5) | | X | ⊚ | ⊚ | ⊚ | □ | ⊚ |
| Comparative | | | 10 | — | 0.5 | ⊚ | ⊚ | ⊚ | □ | □ | ⊚ |
| inventive | | | | | 1 | ⊚ | ⊚ | ⊚ | ⊚ | ⊚ | ⊚ |
| inventive | | | | | 3 | ⊚ | ⊚ | ⊚ | ⊚ | ⊚ | ⊚ |
| Comparative | | | | | 8 | ⊚ | ⊚ | ⊚ | ⊚ | ⊚ | ⊚ |
| Comparative | | | | | 10 | ⊚ | ⊚ | ⊚ | ⊚ | ⊚ | ⊚ |

As seen from the above table 4, the steel sheet having the resin layer formed by coating the resin treatment liquid, whose components are mixed with the predetermined contents in accordance with the present invention, has high solution stability, fuel resistance, corrosion resistance, adhesiveness and weldability. In the above table 4, the respective samples containing silica of 25 parts by weight and phosphoric ester of 8 parts by weight and 10 parts by weight have good properties, but they are not economical because a large amount of components are used.

### Example 4

The Cr-free treatment liquid is coated on the both surfaces of the Zn electroplated steel sheet which is made by plating the cold rolled steel sheet with Zn by the plating amount of 30 g/m². The Cr-free treatment liquid contains silicate of 20 parts by weight, silane of 2 parts by weight, titanium compound 1 parts by weight, urethane resin of 20 parts by weight (which has a number average molecular weight of 1,000), and phosphoric ester of 3 parts by weight based on the Cr-free treatment liquid of 100 parts by weight. The above components are mixed in water. At this time, the dry film coating amount of the Cr-free treatment liquid onto one surface of the steel sheet is 500 mg/m². The steel sheet coated with the Cr-free treatment liquid is baked at the temperature of 190° C. and cooled, to thereby form the Cr-free layer on the both surfaces of the steel sheet. When preparing the Cr-free treatment liquid, silicate, silane and titanium compound are first mixed, and then urethane resin and phosphoric ester are added.

Afterwards, the resin treatment liquid is coated on the both surfaces of the Cr-free layer.

The resin treatment liquid forming the resin layer contains melamine resin of 5 parts by weight, colloidal silica of 15 parts by weight (which has a mean particle diameter of 20 nm), ball-shaped SnO powder of 30 parts by weight (which has a mean particle diameter of 0.5□) and phosphoric ester of 3 parts by weight based on the phenoxy resin of 100 parts by weight (which has a number average molecular weight of 50,000). The above components are sequentially added to the phenoxy resin which is dispersed in water. The resin treatment liquid is adjusted such that the content of the solid becomes 30 wt % by using water.

The evaluation results of the quality of the steel sheet according to this example are shown in the following table 5. The qualitative evaluation items are corrosion resistance, adhesiveness, weldability and fuel resistance which are necessary to the steel sheet for use in a fuel tank. The evaluation conditions of the corrosion resistance and the adhesiveness are the same as those of the example 1, the evaluation conditions of the weldability are the same as those of the example 2, and the evaluation conditions of the fuel resistance are the same as those of the example 3. A thickness of the resin layer is shown in the following table 5.

TABLE 5

| | manufacturing | quality evaluation results | | | | | |
|---|---|---|---|---|---|---|---|
| | conditions | | | | adhesiveness | adhesiveness | |
| | baking temp. | thickness | fuel | corrosion | after | after | |
| examples | (° C.) | (μm) | resistance | resistance | boiling | cup-forming | weldability |
| Comparative | 150 | 500 | □ | □ | Δ | Δ | ⊚ |
| inventive | 190 | | ⊚ | ◯ | ⊚ | ◯ | ⊚ |
| inventive | 210 | | ⊚ | ⊚ | ⊚ | ⊚ | ⊚ |
| inventive | 250 | | ⊚ | ⊚ | ⊚ | ⊚ | ⊚ |
| Comparative | 260 | | ⊚ | ⊚ | ⊚ | ⊚ | ⊚ |
| Comparative | 190 | 100 | □ | X | ⊚ | □ | ⊚ |
| Comparative | | 200 | ⊚ | Δ | ⊚ | ◯ | ⊚ |
| inventive | | 500 | ⊚ | ⊚ | ⊚ | ⊚ | ⊚ |
| inventive | | 1000 | ⊚ | ⊚ | ⊚ | ⊚ | ⊚ |
| Comparative | | 1300 | ⊚ | ⊚ | ⊚ | ◯ | X |

In the table 5, the sample having the baking temperature of 260° C. has sufficient properties, but has shortcoming of high manufacturing costs due to high baking temperature.

As seen from the above table 5, the steel sheet coated with the resin layer which is formed by the predetermined forming conditions (resin layer thickness and baking temperature) in accordance with the present invention, has high corrosion resistance, adhesiveness, weldability and fuel resistance.

### INDUSTRIAL APPLICABILITY

As apparent from the above description, the surface treated Cr-free steel sheet for use in a fuel tank in accordance with the present invention is environmental friendly in comparison with a conventional product using Cr. Further, the Cr-free steel sheet of the present invention satisfies the conditions of corrosion resistance, adhesiveness, weldability and fuel resistance, which are required for a fuel tank.

1. A surface treated Cr-free steel sheet for use in a fuel tank comprising:
a Zn-based electroplated steel sheet;
a Cr-free layer which is formed by a Cr-free treatment liquid coated on the Zn-based electroplated steel sheet, the Cr-free treatment liquid containing silicate of 3 to 40 parts by weight, silane of 0.5 to 10 parts by weight, titanium compound of 0.2 to 8 parts by weight, binder resin of 10 to 50 parts by weight, the binder resin being selected from the group consisting of urethane resin, epoxy resin and a combination thereof, and phosphoric ester of 1 to 5 parts by weight based on the Cr-free treatment liquid of 100 parts by weight; and
a resin layer which is formed by a water-based resin treatment liquid coated on the Cr-free layer, the resin treatment liquid containing melamine resin of 3 to 25 parts by weight, colloidal silica of 10 to 20 parts by weight, metal powder of 5 to 40 parts by weight, and phosphoric ester of 1 to 5 parts by weight based on phenoxy resin of 100 parts by weight.

2. The surface treated Cr-free steel sheet for use in a fuel tank according to claim 1, wherein the Zn-based electroplated steel sheet is made by plating a cold rolled steel sheet with zinc or zinc-nickel alloy with a plating amount of 20 to 30 g/m².

3. The surface treated Cr-free steel sheet for use in a fuel tank according to claim 1, wherein the Cr-free layer is formed with a dry film coating amount of 500 to 1,000 mg/m².

4. The surface treated Cr-free steel sheet for use in a fuel tank according to claim 1, wherein the resin layer is formed with a dry film thickness of 2 to 10 μm.

5. The surface treated Cr-free steel sheet for use in a fuel tank according to claim 1, wherein the silicate is NaSiO₃ and/or NaSi₅O₁₁.

6. The surface treated Cr-free steel sheet for use in a fuel tank according to claim 1, wherein the silane is gamma glycidoxypropyltriethoxy silane and/or gamma aminopropyltriethoxy silane.

7. The surface treated Cr-free steel sheet for use in a fuel tank according to claim 1, wherein the titanium compound is hexafluoro titanic acid which is adjusted to pH 9 to 10 by using amine.

8. The surface treated Cr-free steel sheet for use in a fuel tank according to claim 1, wherein the binder resin has a number average molecular weight of 1,000 or more.

9. The surface treated Cr-free steel sheet for use in a fuel tank according to claim 1, wherein the phenoxy resin has a number average molecular weight of 25,000 to 50,000.

10. The surface treated Cr-free steel sheet for use in a fuel tank according to claim 1, wherein the metal powder has a particle diameter of 0.5 to 1 μm.

11. The surface treated Cr-free steel sheet for use in a fuel tank according to claim 1, wherein the metal powder is selected from the group consisting of Ni, Zn, Al, Cu, SnO and a mixture thereof.

12. The surface treated Cr-free steel sheet for use in a fuel tank according to claim 1, wherein the Cr-free layer is formed on one or both surfaces of the Zn-based electroplated steel sheet.

13. The surface treated Cr-free steel sheet for use in a fuel tank according to claim 1, wherein the resin layer is formed on one or both surfaces of the Cr-free layer.

14. A method for manufacturing a surface treated Cr-free steel sheet for use in a fuel tank, comprising the steps of:
coating a Cr-free treatment liquid on a Zn-based electroplated steel sheet, the Cr-free treatment liquid containing silicate of 3 to 40 parts by weight, silane of 0.5 to 10 parts by weight, titanium compound of 0.2 to 8 parts by weight, binder resin of 10 to 50 parts by weight, the binder resin being selected from the group consisting of urethane resin, epoxy resin and a combination thereof, and phosphoric ester of 1 to 5 parts by weight based on the Cr-free treatment liquid of 100 parts by weight;
forming a Cr-free layer by baking the steel sheet coated with the Cr-free treatment liquid at a metal temperature of 160 to 250° C.;
coating a water-based resin treatment liquid on the Cr-free layer formed on the steel sheet, the resin treatment liquid containing melamine resin of 3 to 25 parts by weight, colloidal silica of 10 to 20 parts by weight, metal powder of 5 to 40 parts by weight, and phosphoric ester of 1 to 5 parts by weight based on phenoxy resin of 100 parts by weight; and
forming a resin layer by baking the steel sheet coated with the resin treatment liquid at the metal temperature of 190 to 250° C.

15. The method according to claim 14, wherein the Zn-based electroplated steel sheet is made by plating a cold rolled steel sheet with zinc or zinc-nickel alloy with a plating amount of 20 to 30 g/m².

16. The method according to claim 14, wherein the Cr-free layer is formed with a dry film coating amount of 500 to 1,000 mg/m².

17. The method according to claim 14, wherein the resin layer is formed with a dry film thickness of 2 to 10 μm.

18. The method according to claim 14, wherein the silicate is NaSiO₃ and/or NaSi₅O₁₁.

19. The method according to claim 14, wherein the silane is gamma glycidoxypropyltriethoxy silane and/or gamma aminopropyltriethoxy silane.

20. The method according to claim 14, wherein the titanium compound is hexafluoro titanic acid which is adjusted to pH 9 to 10 by using amine.

21. The method according to claim 14, wherein the binder resin has a number average molecular weight of 1,000 or more.

22. The method according to claim 14, wherein the phenoxy resin has a number average molecular weight of 25,000 to 50,000.

23. The method according to claim 14, wherein the metal powder has a particle diameter of 0.5 to 1 μm.

24. The method according to claim 14, wherein the metal powder is selected from the group consisting of Ni, Zn, Al, Cu, SnO and a mixture thereof.

25. The method according to claim 14, wherein the Cr-free layer is formed on one or both surfaces of the Zn-based electroplated steel sheet.

26. The method according to claim 14, wherein the resin layer is formed on one or both surfaces of the CR-free layer.

27. A Cr-free treatment liquid comprising:
silicate of 3 to 40 parts by weight; silane of 0.5 to 10 parts by weight; titanium compound of 0.2 to 8 parts by weight; binder resin of 10 to 50 parts by weight, the binder resin being selected from the group consisting of urethane resin, epoxy resin and a combination thereof; and phosphoric ester of 1 to 5 parts by weight, based on the Cr-free treatment liquid of 100 parts by weight.

28. The Cr-free treatment liquid according to claim 27, wherein the silicate is NaSiO₃ and/or NaSi₅O₁₁.

29. The Cr-free treatment liquid according to claim 27, wherein the silane is gamma glycidoxypropyltriethoxy silane and/or gamma aminopropyltriethoxy silane.

30. The Cr-free treatment liquid according to claim 27, wherein the titanium compound is hexafluoro titanic acid which is adjusted to pH 9 to 10 by using amine.

31. The Cr-free treatment liquid according to claim 27, wherein the binder resin has a number average molecular weight of 1,000 or more.

32. A resin treatment liquid comprising:
melamine resin of 3 to 25 parts by weight; colloidal silica of 10 to 20 parts by weight; metal powder of 5 to 40 parts by weight; and phosphoric ester of 1 to 5 parts by weight, based on phenoxy resin of 100 parts by weight.

33. The resin treatment liquid according to claim 32, wherein the phenoxy resin has a number average molecular weight of 25,000 to 50,000.

34. The resin treatment liquid according to claim 32, wherein the metal powder has a particle diameter of 0.5 to 1 μm.

35. The resin treatment liquid according to claim 32, wherein the metal powder is selected from the group consisting of Ni, Zn, Al, Cu, SnO and a mixture thereof.
